(19) United States
(12) Patent Application Publication
(10) Pub. No.: US 2026/0174093 A1
(43) Pub. Date: Jun. 25, 2026

(54) COFFEE GRINDING MACHINE WITH SYSTEM FOR SIMPLIFIED OPENING AND CLOSING OF THE GRINDING CHAMBER

(71) Applicant: LA MARZOCCO S.R.L., SCARPERIA E SAN PIERO (IT)

(72) Inventors: Riccardo GATTI, SCARPERIA E SAN PIERO (IT); Riccardo MARCHI, SCARPERIA E SAN PIERO (IT); Marco BECCASTRINI, SCARPERIA E SAN PIERO (IT)

(21) Appl. No.: 19/127,314

(22) PCT Filed: Nov. 7, 2023
(86) PCT No.: PCT/IB2023/061216

§ 371 Date: May 5, 2025

(30) Foreign Application Priority Data
Nov. 7, 2022 (IT) 102022000022866

(51) Int. Cl. A23F 5/26; A47J 42/50

(52) U.S. Cl. CPC A23F 5/26; A47J 42/50

(57) ABSTRACT

A coffee grinding machine comprising a grinding chamber is described, wherein the grinding chamber comprises a lower part and an upper part, wherein the upper part and the lower part of the grinding chamber can be separated from each other, wherein the grinding chamber is configured to assume a closed working position, in which the upper part is joined to the lower part, and an open position, in which the upper part is separated from the lower part, wherein the lower part of the grinding chamber comprises a first burr, wherein the upper part comprise a second burr configured to cooperate with the first burr in order to grind coffee beans; wherein the upper part also comprises an adjustment mechanism which, in the closed working position, is configured to adjust the relative distance between the first burr and the second burr so as to vary the fineness of the ground coffee; wherein, in the open position, the second burr is connected to the upper part of the grinding chamber and is separated from the first burr, and wherein the upper part and the lower part are, in the closed working position, joined by a magnetic attraction force.

### TECHNICAL SECTOR

The present invention relates to a machine for grinding coffee beans. The machine for grinding coffee beans may be a separate machine or may be incorporated in a machine for the production of coffee-based beverages. Such a machine is also known simply as a “coffee grinding machine”, “coffee grinder” or “mill”.

More particularly, the present invention relates to the opening and closing of the grinding chamber. Even more particularly, it relates to a mechanism which allows simplified opening (and also closing) of the grinding chamber.

### PRIOR ART

As is known, for the preparation of an espresso coffee, a certain amount of ground coffee, usually called a dose, is used. A dose may consist of a single dose, double dose or multiple dose. The dose of ground coffee is filled inside a filter, typically in the form of a cup which is open at the top and has a bottom with micro-perforations. Typically, the dose of coffee is pressed inside the filter so as to form a puck of coffee powder. The filter is in turn supported by a filter holder which is configured to be removably engaged with a dispensing unit of an espresso coffee machine. The espresso coffee is obtained by passing hot water under pressure through the puck of coffee powder.

The coffee powder is obtained by means of a coffee grinding machine. In a known coffee grinding machine, the coffee beans are ground by causing them to pass through grinding members. Grinding members of the flat, conical or mixed type are known. Typically, the grinding members of a coffee grinding machine comprise a fixed member and a member rotating with respect to the fixed member. For example, in a coffee grinding machine with flat burrs, one burr remains at a standstill, stationary, while the other burr is rotated by a motor. Some coffee grinding machines are able to modify the distance between the burrs in order to vary the particle size of the coffee powder.

DE 202007016141 describes a coffee grinding machine with a housing and two grinding discs arranged opposite each other, wherein the engagement of the grinding discs with the flange of the fixed disc or with the flange of the rotor is performed by means a magnet connected to the flange of the fixed disc or the flange of the rotor.

US 2012/0168544 describes a grinder for grinding tobacco leaves.

### SUMMARY OF THE INVENTION

The Applicant has carefully examined the known coffee grinding machines.

As is known, in the known coffee grinding machines, both for domestic use and professional use, it is desirable to be able to vary in a precise, repeatable and stable manner the distance between the burrs. This function allows the particle size of the coffee powder thus produced to be adjusted so as to obtain a series of advantages.

For example, it is possible to obtain different particle sizes suitable for the various types of extraction operation, ranging from extra-fine to coarser particle sizes.

It is desirable that the user, when adjusting the particle size, should be able to perform the operation comfortably and feel an easy movement.

It is also desirable that the particle size adjustment operation should be simple and that it should be relatively easy to read the set value.

In order to obtain, at least partially, the aforementioned characteristics, it is necessary that the burrs and all the components which form the grinding chamber should be rigid and extremely stable. At the same time, in particular in the case of “on-demand” coffee grinding machines, namely machines which grind the dose from a pre-dosed quantity of coffee beans, it is necessary that the grinding chamber should be easy to open and that at least some of the components can be separated from each other.

Opening of the grinding chamber is necessary in order to view the state of wear of the burrs, but in particular in order to be able to remove any coffee residues.

By removing the coffee residues it is generally possible to perform cleaning of the grinding chamber. Cleaning of the grinding chamber and the burrs should be done regularly, but it is obviously recommended to do so before an interruption-even for a short period of time-in use of the coffee grinding machine. In fact, the coffee residues tend to oxidise easily and become rancid. If it they are not removed, the coffee residues may result in the formation of mould. The mould negatively affects the quality of the ground coffee, in particular of the first ground doses.

The removal of the coffee residues, in the case where preselected doses are ground, in particular high-quality doses, is necessary to ensure that the entire quantity of the coffee beans introduced into the machine may be collected in ground form. This may be easily achieved with the aid of a small brush after opening the grinding chamber.

More generally, the removal of the coffee residues is highly recommended when the type of coffee to be ground is changed.

Coffee grinding machines equipped with systems for opening the grinding chamber are known. In order to ensure rigidity, in many applications, the grinding chamber can be opened by removing one of the burrs with the aid of tools, such as screwdrivers or Allen keys. The use of tools discourages users from regularly opening the grinding chamber in order to carry out cleaning and maintenance.

The Applicant has therefore defined the aim of finding a reliable and advantageous solution for opening the grinding chamber in a safe and easy manner and closing it in a stable and reliable manner.

According to the Applicant, the aforementioned object, along with others, is achieved in a coffee grinding machine comprising a grinding chamber, closing of which is ensured by a magnetic force and opening of which, on the other hand, is performed by the user by exerting a force opposite to the magnetic closing force. Advantageously, according to embodiments, tools for opening the grinding chamber are not required.

Simplification of opening of the grinding chamber according to the present invention is very advantageous for the user, in particular if tools are not required. In this way, the cleaning cycles may be performed more frequently and do not require the assistance of a technical person (especially in a domestic environment).

The present invention is applicable to any coffee grinding machine, in particular with flat burrs, conical burrs or mixed burrs.

The Applicant has noted that the solution described in DE 202007016141 does not solve the problem of facilitating opening of the grinding chamber. In fact, the upper part and the lower part of the grinding chamber are joined together by means of a thread.

Moreover, the Applicant has noted that the solution described in DE 202007016141, whenever the grinding chamber is opened, by unscrewing the upper part from the lower part, the fineness setting is lost. Therefore adjustment of the fineness must be performed again when the upper part is screwed back onto the lower part of the grinding chamber. This operation is inconvenient and therefore the user is discouraged from performing it frequently. Opening of the grinding chamber should instead be performed daily or in any case frequently in order to clean the burrs of the coffee powder and thus prevent the coffee left between the burrs from becoming rancid.

According to a first aspect, the present invention provides a coffee grinding machine for grinding coffee beans, comprising a grinding chamber, wherein the grinding chamber comprises a lower part and an upper part, wherein the upper part and the lower part of the grinding chamber can be separated from each other, wherein the grinding chamber is configured to assume a closed working position, in which the upper part is joined to the lower part, and an open position, in which the upper part is separated from the lower part, wherein the lower part of the grinding chamber comprises a first burr, wherein the upper part comprises a second burr configured to cooperate with the first burr for grinding coffee beans, wherein the upper part also comprises an adjustment mechanism which, in the closed working position, is configured to adjust the relative distance between the first burr and the second burr so as to vary the fineness of the ground coffee; wherein, in the open position, the second burr is connected to the upper part of the grinding chamber and is separated from the first burr, and wherein the upper part and the lower part are, in the closed working position, joined by a magnetic attraction force. Basically, the second burr is integral with the upper part of the grinding chamber and, when the upper part is separated from the lower part, the two burrs are separated. In this way, the burrs may be cleaned of the residual coffee separately and easily, for example using compressed air and/or a brush. Advantageously, the adjustment mechanism forms part of the upper part of the grinding chamber. The adjustment is maintained also when the grinding chamber is opened and the burrs are separated from each other. The adjustment mechanism is independent of the magnetic arrangement for closing the grinding chamber.

According to the present invention the upper part and the lower part are not joined together with screws or bolts.

According to embodiments, the lower part of the grinding chamber comprises a single magnet or a plurality of magnets.

According to embodiments, the single magnet or the plurality of magnets are arranged in the thickness of the lower part of the grinding chamber.

According to embodiments, the upper part of the grinding chamber comprises a single magnet or a plurality of magnets.

According to embodiments, the magnets are in the form of pins and, preferably, are arranged angularly equally spaced.

According to embodiments, the part of the grinding chamber opposite to that which comprises the magnets comprises a body made of ferromagnetic material.

According to embodiments, the first burr is connected mechanically to the lower part of the grinding chamber by means of screws or other threaded members.

According to embodiments, the second burr is connected mechanically to the upper part of the grinding chamber by means of screws or other threaded members.

According to embodiments, the second burr is integral with a threaded burr-holder disc and the adjustment device comprises a ring nut.

According to embodiments, the ring nut comprises an inner ring nut on which an adjustment thread is formed and an outer ring nut which acts as a grip for the operator.

According to embodiments, a sliding track is arranged between the lower part and the upper part.

According to embodiments, locating members are provided for coupling together the lower part and the upper part in a predefined position.

According to embodiments, the locating members comprise teeth projecting radially inwards from the inner circumference of the sliding track and corresponding notches in the burr-holder disc or notches on the lower part of the grinding chamber and teeth on the burr-holder disc.

According to embodiments, the teeth are not arranged angularly equally spaced and/or have a different shape from each other and/or have a different size from each other.

### BRIEF DESCRIPTION OF THE DRAWINGS

A detailed description of the invention now follows, being provided purely by way of a non-limiting example, to be read with reference to the accompanying figures in which:

FIG. 1.1 is a schematic view of a coffee grinding machine according to an embodiment of the present invention;

FIG. 1.2 is a longitudinal section through the machine shown in FIG. 1.1;

FIG. 2 is a longitudinal section, on a larger scale, through the grinding chamber according to an embodiment of the present invention;

FIG. 3 is a longitudinal section, on a larger scale, through the grinding chamber of FIG. 2 with the ring nut assembly uncoupled;

FIG. 4 shows a longitudinally sectioned view of disassembly of the fixing screws and the sliding plate;

FIG. 5 shows an axonometric view, from above, of the fixing screws and the sliding plate in the disassembled condition;

FIG. 6 shows an axonometric view, from below, of the fixing screws and the sliding plate in the disassembled condition;

FIG. 7 shows a second embodiment of the grinding chamber, closing of which is performed by means of a magnetic attraction force; and

FIG. 8 is an exploded axonometric view of the lower part of the grinding chamber.

### DETAILED DESCRIPTION

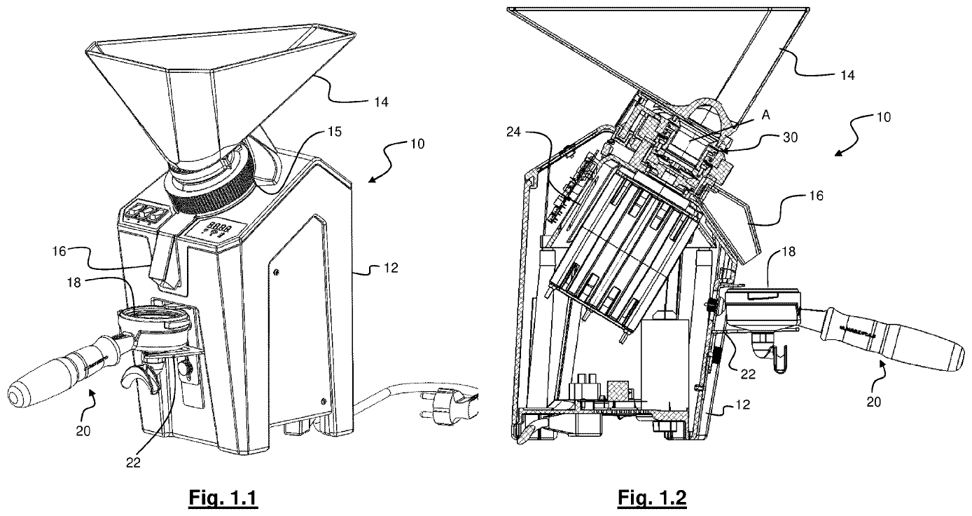

FIG. 1.1 and 1.2 show a coffee grinding machine according to an example of embodiment of the present invention. Obviously, the coffee grinding machine according to the invention may assume a form totally different from that shown without thereby departing from the scope of protection of the present invention.

The machine 10 comprises a machine body 12 which contains the main components, including a grinding chamber 30 with a burr assembly 36. Typically the machine 10 comprises a hopper 14 in its upper part. The hopper 14 is configured to contain the coffee beans to be ground and allow the coffee beans to reach the grinding chamber 30 and the burr assembly 36.

The machine 10 also comprises a device for adjusting the fineness of the ground powder. The adjustment device will be described more fully below.

The machine 10 also comprises an outlet duct 16 for directing the ground coffee towards the filter 18 which is in turn supported by a filter holder 20. Advantageously there may be provided a support 22 for supporting the filter holder 20 during filling of the filter 18 with the ground coffee powder. The support 22 may be adjustable heightwise. In FIG. 1.1 also visible are pushbuttons 26 for operating the coffee grinding machine, as well as LEDs (or a display) for showing the status of the machine 10.

FIG. 1.2 shows a longitudinally sectioned view of the machine shown in FIG. 1.1. In addition to the components already mentioned, the burr assembly and an electric motor 24 for rotation of one burr with respect to the other one are shown.

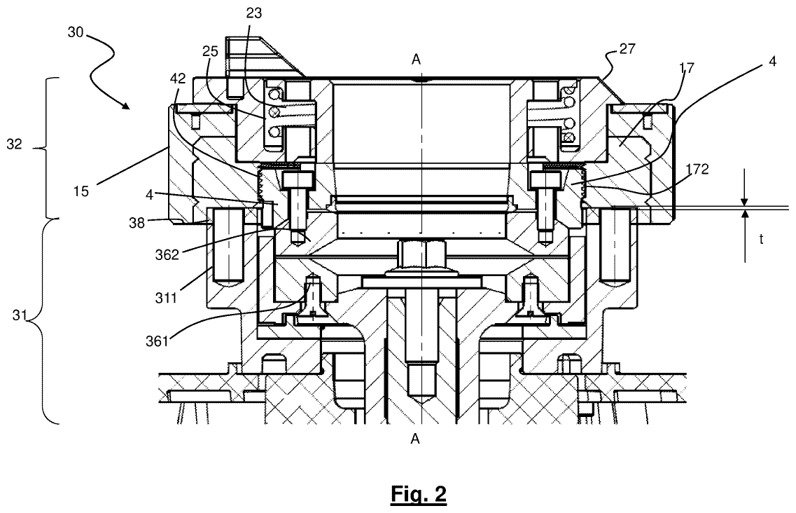

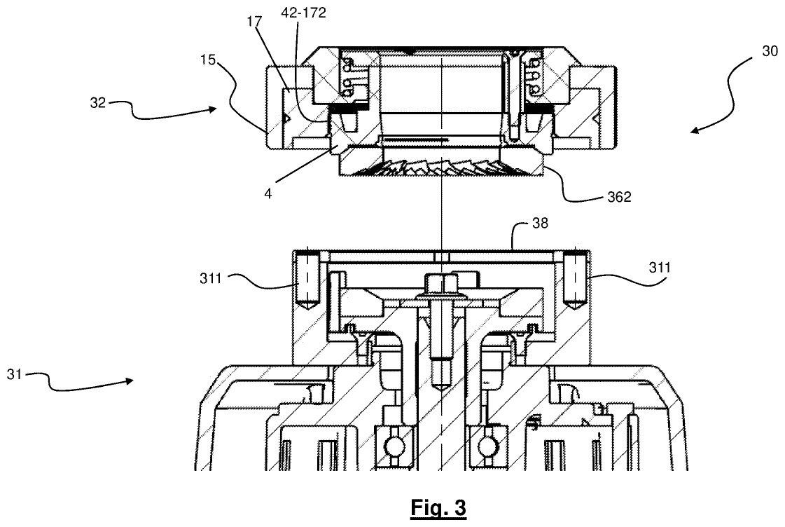

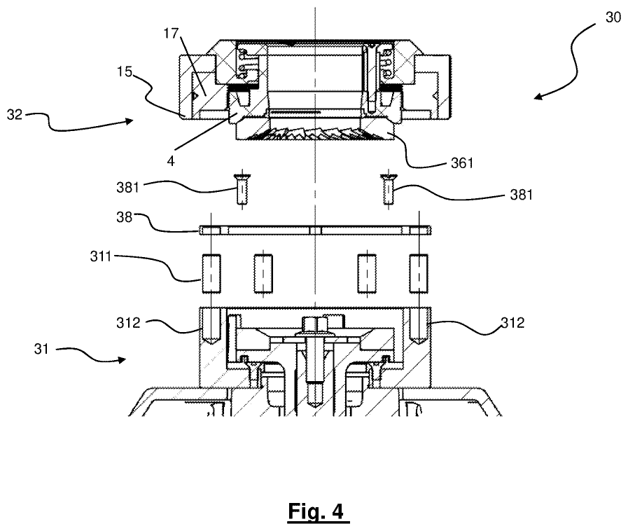

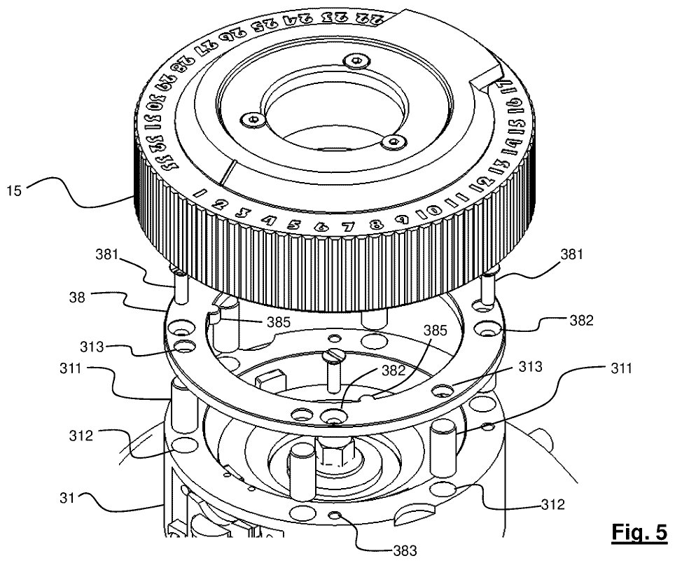

The burr assembly (and the grinding chamber 30 according to a first embodiment) is shown in greater detail in the various FIGS. 2-6.

The various FIGS. 2-6 show the grinding chamber 30 with the burr assembly, in turn comprising a lower burr 361 and an upper burr 362. The grinding chamber 30 comprises a lower part 31 and an upper part 32. The lower part 31 of the grinding chamber houses the lower burr 361. The upper part 32 of the grinding chamber comprises the upper burr 362.

According to the embodiment shown, the lower burr 361 is the movable burr. It is kinematically connected to the motor shaft in any known manner. The connection may be performed, for example, by means of a flanged burr-holder disc 361 which rotatably supports the lower burr 361.

Advantageously, the flanged disc may be provided with suitable radial profiles which are designed to expel the ground coffee exiting the burrs 361, 362 from the grinding chamber 30.

It is clear that in the present description and in the associated drawings the arrangement of the axis A of the burrs 361, 362 is vertical. However, the present invention is applicable also to coffee grinding machines with an axis of the burrs which is horizontal or inclined differently from the vertical. In fact, as shown in FIG. 1.2, the axis A of the burrs is inclined with respect to the vertical. The burrs may also be arranged differently so as to have the burr movable at the top or so as to have two movable burrs. Finally, as mentioned above, the present invention is also applicable in the case of conical burrs.

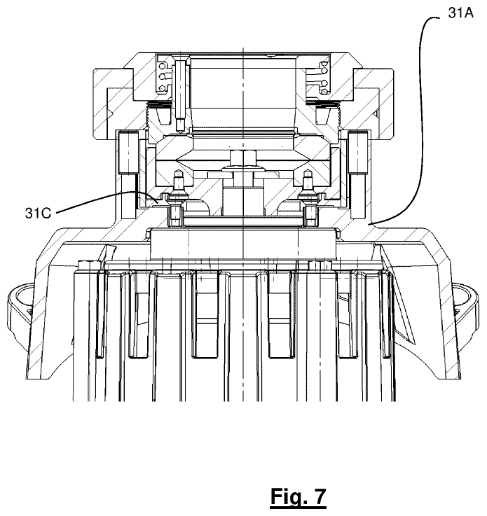

The upper burr 362 is aligned on the same axis A. The upper burr 362 is integral with a burr-holder disc 4. The burr-holder disc 4 is preferably rigidly connected to the upper burr 362, for example by means of screws 41 (FIG. 7). The burr-holder disc 4 comprises a cylindrical outer surface and a thread 42 on at least a part of the outer surface.

An inner adjustment ring nut 17 is arranged radially on the outside of the burr-holder disc 4. The inner adjustment ring nut 17 comprises a thread 172 which mates with the thread 42 of the burr-holder disc 4.

An outer adjustment ring nut 15 is arranged radially on the outside of the inner ring nut 17. The outer ring nut 15 may be at least partially made of a thermoplastic material and acts as a grip for the operator.

As will become clearer below, when the grinding chamber is closed, the burr-holder disc 4 (and therefore the upper burr 362 connected to it) is configured so as not to be able to rotate with respect to the lower part of the grinding chamber. Therefore, the rotation of the ring nut causes the displacement of the burr-holder disc 4 and the upper burr 362. The axial displacement may take place in a first direction towards the lower burr or in a second direction away from the lower burr.

When the grinding chamber is opened, the pre-set adjustment is not lost, but remains the same when the grinding chamber is closed again. This is due to the fact that grinding adjustment mechanism is independent of the way in which the upper part of the grinding chamber is coupled to the lower part of the grinding chamber.

The operator may rotate the outer ring nut 15 in order to increase/decrease the fineness of the ground coffee. The outer ring nut and the inner ring nut may be connected together by means of a scored profile of the toothed type and uncoupled by means of axial sliding by a certain amount.

According to embodiments of the present invention, the inner ring nut 17 is made, at least partially, of a ferromagnetic material.

According to embodiments of the present invention, the inner ring nut 17 is made substantially entirely of ferromagnetic material.

The ferromagnetic material may be chosen, for example, from the group comprising iron, steel, nickel, cobalt, chrome or any combination thereof. A spring 23 is provided. The spring 23 pushes the upper burr upwards, in the same direction as the pushing force acting on the coffee during grinding. This in order to eliminate the play of the adjustment thread. The spring 23 is mounted in an upper seat 25 formed in an upper cap 27.

According to a first embodiment, at least one magnet 311, substantially integral with the lower part 31 of the grinding chamber, is provided. According to embodiments, a plurality of magnets 311 is provided.

The magnets 311 may be, for example, in the form of pins inserted in the wall of the lower part 31 of the grinding chamber 30. This solution is shown in FIGS. 2-6. The magnetic pins 311 may consist of any number, for example 2, 3, 4, 5 or 6 (as in the specific example shown in the figures). Each pin 311 is inserted inside a hole 312 formed in the thickness of the wall of the lower part 31 of the grinding chamber 30.

According to embodiments, the holes 312 are equally angularly spaced, but may also be differently arranged.

According to embodiments, a sliding track 38 may be arranged on the upper surface of the lower part 31 of the grinding chamber 30. The sliding track 38 may be, for example, formed directly in the grinding chamber, or made of a different material, which is preferably non-magnetic and has specific friction characteristics, for example bronze, brass, polymer, steel which may be provided with anti-wear and anti-friction coatings, as well as sintered material.

The sliding track 38 is, for example, in the form of a circular rim and has a small thickness. The thickness may, for example, be equal to a few millimetres, for example 2-6 mm. In other embodiments, the sliding track might not be present, since the functionality could be ensured also with the sliding track formed directly on the grinding chamber.

The sliding track 38 may be fixed to the top of the lower part of the grinding chamber by means of screws 381, which are inserted in respective through-holes 382 in the sliding track 38 and in respective blind holes 383 in the wall of the lower part 31 of the grinding chamber 30.

Advantageously, the heads of the magnetic pins 311 are substantially flush with the upper surface of the sliding track 38 since each of them passes through a through-hole 313.

The sliding track 38 has the purpose of favouring rotational sliding of the inner ring nut 17. This sliding action may be necessary in order to ensure the fluidity and the precision of the positional adjustment of the burrs. The sliding action is also necessary in order to determine the axial position of the burr-holder disc 4 and consequently the grinding adjustment (relative distance between the two burrs).

The predetermined position may be defined by means of locating members which are present in the sliding track 38 and/or in the ring nut body 17 directly facing the sliding track 38. The predetermined position must be provided between the sliding track 38 and the upper burr-holder disc 4, for example by means of teeth and notches which will be described below.

Said radial connection ensures that the burr-holder disc 4 does not rotate, but is able to slide axially by means of rotation of the outer ring nut 15 via the threading 42-172.

The teeth could also form part of the grinding chamber 30.

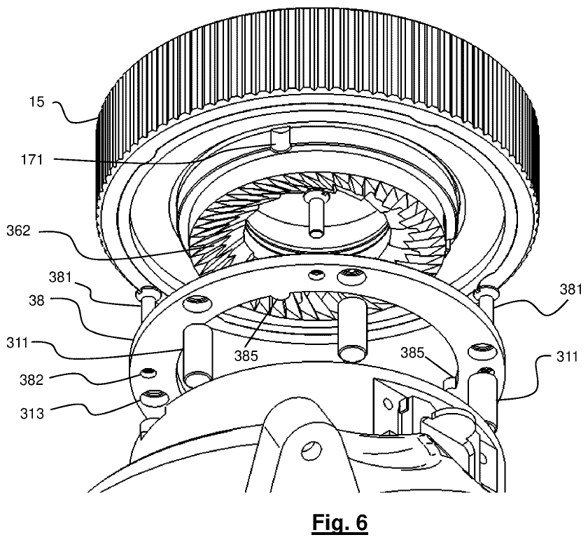

By way of example, the various figures show an embodiment of the locating members comprising teeth 385 projecting radially inwards from the inner circumference of the sliding track 38 and corresponding notches 171 in the inner ring nut 17. One of the notches 171 is visible in FIG. 6. Obviously, the same function may be performed by other locating members and in any case the notches could be situated on the sliding track (or in any case on the lower part of the grinding chamber) and the teeth could be situated in the inner ring 17.

In the embodiment, the teeth 385 and the notches 171 are three in number but could also consist of a smaller number (even one) or a greater number. In order to establish a unique relative position of the inner ring nut 17 and the sliding track 38 (in turn integral with the lower part 31 of the grinding chamber 30), the teeth 385 and the notches 171 are not angularly equally spaced. In this way, there is essentially a unique position for coupling the ring nut body 17 to the grinding chamber. In order to find this unique coupling position it could be necessary to rotate either one relative to each other in the clockwise or anti-clockwise direction.

Alternatively, the notches 171 (and similarly the teeth 385) might not have the same form and/or same size.

Once the correct and stable coupling position has been found, the inner ring nut 17 becomes locked with respect to the lower part 31 of the grinding chamber 30 by means of the magnetic attraction force between the magnets 311 and the ring nut body 17 made of ferromagnetic material.

The number of magnets 311 and their diameter have dimensions such as to provide an attraction force sufficient for ensuring stable and reliable coupling.

In order to open the grinding chamber, the user must simply raise the upper part, namely the inner ring nut 17 (together with the outer ring nut 15, the upper burr 362 and he burr-holder disc 4), against the magnetic attraction force between the magnets 311 and the inner ring nut 17 made of ferromagnetic material. In order to perform opening, the user does not have to user any tools (for example a screwdriver, spanner or Allen key). Since the upper burr is integral with the upper part of the grinding chamber, by raising the upper part of the grinding chamber, the burrs are separated from each other: the lower burr will remain with the part of the lower chamber and the upper burr will be substantially integral with the upper part of the grinding chamber. In this way, the two burrs may be separately cleaned and inspected.

Advantageously, the upper chamber will maintain the grinding fineness adjustment. In other words, when the upper part of the grinding chamber is coupled again with the lower part, the relative distance between the burrs will be maintained as it was before opening of the grinding chamber. This represents a big advantage which does not discourage opening of the grinding chamber (typically for cleaning purposes).

Obviously, although in the present description the magnets have been described as being fixed to the lower of the grinding chamber and the body made of ferromagnetic material as being in the top part (inner ring nut), the opposite situation is also possible, namely with the magnets in the upper part and ferromagnetic material in the lower part, or a combination of the two solutions is possible.

Advantageously, an air gap may be provided between the magnets and the ferromagnetic material. The air gap is indicated by t in FIG. 2.

The present invention ensures perfect relative aligned positioning of the two burrs during the working phases.

Furthermore, an optimum stability of the ring nut in the set adjustment position is provided, ensuring stability during grinding.

Furthermore, an optimum sliding action and fluid movement of the ring nut is ensured, by suitably adjusting the attraction force and the coefficient of friction acting on the sliding track.

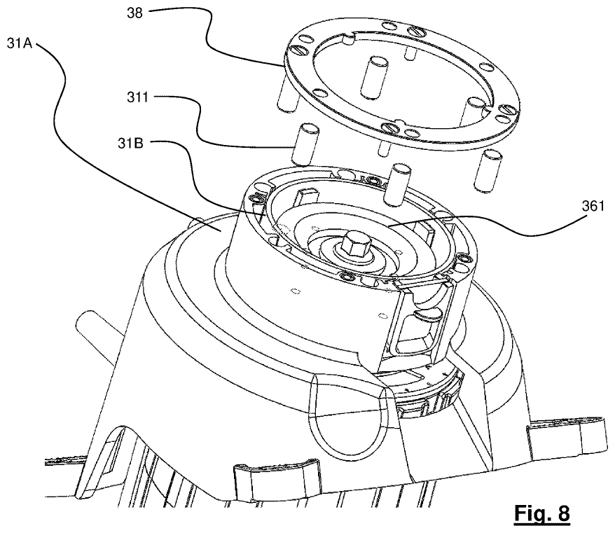

FIGS. 7 and 8 show another embodiment of the present invention. 31A indicates a bell member for supporting the motor assembly which is not made of metallic material. For example, it may be made of thermoplastic material. It substantially lines the lower part of the grinding chamber. The seats of the magnets 311 are formed thereon.

31B denotes the lower part of the grinding chamber. Considering that it is surrounded by the wall integral with the bell member 31A, the wall of the lower part of the grinding chamber may be relatively thin. For example, it may be metallic (for example made of stainless steel) with a thickness of a few millimetres, for example 2 mm.

31C denotes the base of the grinding chamber made of stainless steel. This second embodiment shows that the magnets could also not be arranged in the thickness of the lower part of the grinding chamber, but could also be integral with a wall outside the actual grinding chamber.

For the purposes of the present invention, the “wall of the lower part of the grinding chamber” will be a single wall (for example made of metallic material such as stainless or the like) or a multi-layer wall (for example with an inner layer and an outer layer). The multi-layer wall could comprise layers made of different materials.

It is clear that the present invention results in significant improvements compared to the solution described in DE 202007016141. In particular, the adjustment device is integral with the upper part of the grinding chamber and is configured to maintain the grinding setting also when the upper part of the grinding chamber is separated from the lower part.

Furthermore, according to the invention, the burrs may be made of any material, for example stainless steel, ceramic material, etc.

1. A coffee grinding machine for grinding coffee beans, comprising a grinding chamber, wherein the grinding chamber comprises a lower part and an upper part, wherein the upper part and the lower part of the grinding chamber can be separated from each other,
wherein the grinding chamber is configured to assume a closed working position, in which the upper part is joined to the lower part, and an open position, in which the upper part is separated from the lower part,
wherein the lower part of the grinding chamber comprises a first burr,
wherein the upper part comprises a second burr configured to cooperate with the first burr in order to grind coffee beans;
wherein the upper part further comprises an adjustment mechanism which, in the closed working position, is configured to adjust the relative distance between the first burr and the second burr so as to vary the fineness of the ground coffee;
wherein, in the open position, the second burr is connected to the upper part of the grinding chamber and is separated from the first burr, and
wherein the upper part and the lower part are, in the closed working position, joined by a magnetic attraction force.

2. The coffee grinding machine of claim 1, wherein the lower part of the grinding chamber comprises a single magnet or a plurality of magnets.

3. The coffee grinding machine of claim 2, wherein the single magnet or the plurality of magnets are arranged in the thickness of the lower part of the grinding chamber.

4. The coffee grinding machine of claim 1, wherein the upper part of the grinding chamber comprises a single magnet or a plurality of magnets.

5. The coffee grinding machine of claim 4, wherein the magnets are in the form of pins and, preferably, are arranged angularly equally spaced.

6. The coffee grinding machine of claim 1, wherein the part of the grinding chamber which is opposite to that which comprises the magnets comprises a body made of ferromagnetic material.

7. The coffee grinding machine of claim 1, wherein the first burr is mechanically connected to the lower part of the grinding chamber by means of screws or other threaded members.

8. The coffee grinding machine of claim 1, wherein the second burr is mechanically connected to the upper part of the grinding chamber by means of screws or other threaded members.

9. The coffee grinding machine of claim 1, wherein the second burr is integral with a threaded burr-holder disc and wherein the adjustment device comprises a ring nut.

10. The coffee grinding machine of claim 9, wherein the ring nut comprises an inner ring nut on which an adjustment thread is formed and an outer ring nut which acts as a grip for the operator.

11. The coffee grinding machine of claim 1, wherein a sliding track is arranged between the lower part and the upper part.

12. The coffee grinding machine of claim 11, wherein locating members are provided for coupling together the lower part and the upper part at a predetermined position.

13. The coffee grinding machine of claim 12, wherein the locating members comprise teeth projecting radially inwards from the inner circumference of the sliding track and corresponding notches in the burr-holder disc or notches on the lower part of the grinding chamber and teeth on the burr-holder disc.

14. The coffee grinding machine of claim 13, wherein the teeth are not arranged angularly equally spaced and/or have a different shape from each other and/or have a different size from each other.
